(19) United States
(12) Patent Application Publication
(10) Pub. No.: US 2019/0111606 A1
(43) Pub. Date: Apr. 18, 2019

(54) EXTRUDING PROCESS TO CREATE A STRUCTURAL FORM FOR BUILDING AND CONSTRUCTION APPLICATIONS

(71) Applicant: Neauvotec, LLC, Auburn Hills, MI (US)

(72) Inventor: Miguel A. Linares, Bloomfield Hills, MI (US)

(73) Assignee: Neauvotec, LLC, Auburn Hills, MI (US)

(21) Appl. No.: 16/160,097

(22) Filed: Oct. 15, 2018

Related U.S. Application Data
(60) Provisional application No. 62/572,265, filed on Oct. 13, 2017.

(51) Int. Cl. B29C 47/06; B29C 47/00; B29C 47/08; E04C 3/28; E04C 3/29

(52) U.S. Cl. CPC B29C 47/06; B29C 47/0009; E04C 3/29; E04C 3/28; B29C 47/085

(57) ABSTRACT

An extruding process and assembly for creating a structural form, which includes the steps of bundling and conveying at least one length of a material into an extruder, reshaping a cross section of the bundle in a first stage of the extruder, extruding a material using any combination of heat and pressure around and between the lengths of material, and outputting a finished article having a cross sectional profile in which the materials are structurally supported by the extruded and hardened material. Other steps include an intermediate chilling stage between reshaping and extruding, and for preventing the extruded material from back flowing. The extruded material further includes any of a polymeric or structural foam material and can exhibit any of a rounded, square, rectangular or I beam cross sectional profile.

### CROSS REFERENCE TO RELATED APPLICATIONS

The present application claims the priority of U.S. Ser. No. 62/572,265 filed Oct. 13, 2017, the contents of which are incorporated by reference.

### FIELD OF THE INVENTION

The present invention relates generally to extruding processes for creating structural articles. More particularly, the present invention discloses such an extruding process for creating a structural form, not limited to any of building blocks, sheets and the like, and such as is used in building and other construction applications. A further embodiment of the present invention teaches any type of encapsulation or coating process for applying a polymeric or structural foam material over any fiber structure, such as a frame, seat, flooring support or any other substrate, and which can be utilized in any of a vehicle or other support structure.

### BACKGROUND OF THE RELEVANT ART

The prior art is documented with examples of structural articles which are extruded or otherwise coated with a plastic or other expandable or settable material. One example is depicted in U.S. Pat. No. 9,962,894 to McDonald, which discloses a press for flattening halved bamboo stalks or other workpieces without loss of volume or splintering.

In McDonald, a first mechanical movement is executed by a pushrod drive train, a plurality of spreader bar assemblies press upon the centerline of a workpiece such that the workpiece does not move off of a work surface but is yet not over crushed. Each spreader bar assembly may comprise two spreader bars hingedly attached to a pushrod. The lower end of the pushrod and proximal ends of the spreader bars pin down the workpiece. In a second mechanical movement executed by a crusher bar drive train, the distal ends of the spreader bars are moved outwardly and spread apart the curved walls of the workpiece. In the last phases of a second movement, planar track plates press downwardly upon the workpiece.

U.S. Pat. No. 7,147,745, to Slaven, teaches a bamboo building material and process of manufacture. The material includes a plurality of layers each formed of bamboo segments which have been dried and glue coated. The segments are substantially free of outer nodes and husk and inner membrane, material prior to application of glue. The longitudinal axes of the segments in each layer are generally parallel to one another, with each layer having segments oriented generally orthogonally with respect to the next adjacent layers thereto. The layers of segments are compressed and bonded together until the glue cures into a single integral structure.

Finally, U.S. Pat. No. 5,779,961, to Teutsch, discloses is a process for making a resin extruded lineal profile structure. The profile extends in an axial direction and has a plurality of continuous discrete fiber bundles radially spaced apart and extending longitudinally substantially along the entire length of the structure. A thermoplastic resin directly contacts the respective fiber bundles along the length thereof.

### SUMMARY OF THE PRESENT INVENTION

The present invention discloses an extruding process and assembly for creating a structural form, and which includes the steps of bundling and conveying at least one length of a material into an extruder, reshaping a cross section of the bundle in a first stage of the extruder, extruding a material using any combination of heat and pressure around and between the lengths of material, and outputting a finished article having a cross sectional profile in which the materials are structurally supported by the extruded and hardened material.

Other steps include an intermediate chilling stage between reshaping and extruding, and for preventing the extruded material from back flowing. The extruded material further includes any of a polymeric or structural foam material and can exhibit any of a rounded, square, rectangular or I beam cross sectional profile.

Also disclosed is a related extruding process and assembly for creating a structural form, including the steps of infusing a finely graded naturally occurring material within an extruded material, forcing the infused combination through a cross die head structure associated with an extruder, and forming a partially hollowed cross sectional profile exhibiting any combination of ribs or compartments.

A further related process for encapsulating a pre-assembled frame article, is provided and includes configuring a plurality of naturally occurring fiber structures into a skeletal frame, following which the skeleton is encapsulated with a structural foam. Additional features include integrating a mounting or support hardware components not limited to a plastic or metal into locations of the fiber skeleton, as well as incorporating any of a fabric, carpet, foam or upholstery into the skeleton structure.

The skeleton frame can further include any of a vehicle, floor, side, or base structure, or seat. In the instance of a floor structure, underside structural supporting conduit attachments can be integrated therewith. In additional variations, the skeleton frame may further include a furniture structure, a netting material being looped around a rod which is locked inside of a metal tube with a through defined slot within a side supporting section of the structure, the tube being integrated as a separate fitting or component in addition to naturally occurring structural supporting components and about which is encapsulated the structural sealing and supporting material.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of a line process for extruding a structural and environmental sealing coating about successive bundled pluralities of naturally occurring materials according to one embodiment of the present inventions;

FIG. 2 is an illustration from FIG. 1 of a selected bundled plurality of naturally occurring material, such having any of stiff, rigid or fibrous physical properties and not limited to any of bamboo, bamboo strips, cane stalks, corn stalks, palm leaves, reeds, and the like;

FIG. 3 is an illustration of a succeeding operation including a three stage extruder depicted in cutaway and through which the unbundled bunch of materials are successively conveyed in order to shape and extrude the applied materials, such including but not limited to any of a foaming polyurethane, polyurea, polyethylene, bio-plastic or the like, such further optionally including any infused filler, natural fiber, carbon fiber, metal particulates, shavings, or the like;

FIG. 3A is an enlarged depiction of FIG. 3 and illustrating the three stages of the extruder, this including each of a first stage for reshaping the cross sectional area of the unbundled plurality of materials to that corresponding to the profile defined within the extruder, a third end heated stage in which the extrusion material is heated, liquefied and pressure introduced around and between the individual structural materials which are distributed within the open interior profile of the extruder, a second intermediate chilling stage separating the first formation stage and the third material extrusion stage and which operates to prevent the extruded material from flowing backwards into the first bundling stage;

FIG. 4 is an illustration of a finished extruded structural product, shown from another angle compared to FIG. 1 and which is cut to length in a succeeding operation prior to package and shipment for subsequent use or installation;

FIGS. 5A-5C illustrate examples of extruded round cross sectional posts which include different sized structural materials including a single larger diameter hollowed member (FIG. 5A), a small plurality of intermediate diameter cross sectional distributed members (FIG. 5B) and a larger plurality of smallest diameter members (FIG. 5C) about and between which the extruded material is applied;

FIGS. 6A-6C are similar to FIGS. 5A-5C and illustrate examples of extruded square cross sectional posts which similarly utilize larger, medium and smallest cross sectional diameter structural members;

FIGS. 7A-7B illustrate a further variant of a rectangular cross sectional structural article which is produced with preformed and cross cut lengths (bamboo) of intermediate (FIG. 7A) and smallest (FIG. 7B) diameter and about which is extruded the structurally supporting binding and sealing material;

FIGS. 8A-8C illustrate additional unique “I” beam like structures which can include varying orienting structure for pre-forming the naturally occurring material from intermediate diameter and varying oriented sections of material (FIGS. 8A-8B) prior to extruding the outer structural supporting material, with FIG. 8C depicting a smallest diameter and larger plurality of elongated structural materials, such as which can be passed through the extruder of FIG. 1, and about and between which is introduced the structural supporting and sealing extruded material;

FIGS. 9A-9B illustrate a pair of extruding operations in which a suitable arrangement of structural materials, either extending widthwise as in FIG. 9A or lengthwise as in FIG. 9B, is fed continuously through the extruder for applying a thinner cross sectional profile as compared to FIGS. 7A-7B;

FIGS. 10A-10B illustrate first and second sub-variants of a ply-fiber material arranged in a weaved pattern prior to extruding, in the instance of FIG. 10B a perforated pattern being formed through the material for providing additional extrusion adhesion;

FIG. 11 is an illustration of a further embodiment of the present invention incorporating a redesigned extruder, shown in cutaway, and operating in a single stage through which is inputted an infused structural material contained within the extrudant, this being oriented by the tool for extruding according to a detailed cross sectional profile to create a detailed structural article;

FIG. 11A is an end perspective of the extrusion shown in FIG. 11;

FIG. 11B is a further end perspective of a reconfiguration of the extruder in FIG. 11 which enables the production of another detailed profile;

FIG. 12 is an illustration of a fiber structure in a further embodiment, which can form any multi-component frame structure not limited to any type of vehicle (car, bus, truck, golf cart) or marine craft, and which is encapsulated with a similar polyurethane, polyurea, polyethylene or bioplastic material;

FIG. 13 is a rotated perspective of a side section of the frame structure of FIG. 12 and which includes any natural fibrous material not limited to bamboo, sugarcane, plant stalks, corn, phragmite (tall grasses), etc., such as which are formed of any of whole poles or strips/fibrous composites, and subsequently encapsulated by any type of structural foam;

FIG. 14 is an illustration of a performed structure, such as used for any structural body frame or interior application, and which is assemble together prior to encapsulation with the polymer based structurally supporting material (such further including any structural foam which may include strands of fibers added for rigidity), the structure including hollow conduit like material which can also include any of a metal or plastic;

FIGS. 15A and 15B respectively present upper and underside perspective illustrations of a pre-formed flooring structure, such as for any interior, trunk wall or flooring application, the structure including any of bamboo, bamboo strips, corn, sugarcane, what or any other natural occurring fibrous material, with metal or plastic optionally being integrated into the structure for part attachment locations, additional features including fabric or carpet which can be in-molded during encapsulation as well as providing under supporting hollow conduit support structures such as for routing electrical wiring;

FIG. 16A illustrates a seat application of the fibrous material encapsulating process and assembly, this including an interior structural application with metal or plastic brackets integrated into the structure for subsequent part attachment;

FIG. 16B is a succeeding view to FIG. 16A illustrates an open (hollow interior) structure or more solid interior structure made up of integrated strands or fibers and in which a fabric material can be molded on during the encapsulation process;

FIG. 16C is a further succeeding view depicting the addition of an encapsulating foam, such providing a structural process which is not only lighter but, by integrating more components into one bonded part, it reduces vibration or rattle incidences along with reducing assembly time;

FIG. 16D is a further succeeding illustration of a final upholstery attached to the completed seat;

FIG. 17A is an illustration of a furniture structure which is preformed then encapsulated with any type of structural foam, such as which can further incorporate any fiber of filler additive for improved strength and to provide enhanced hardware attachment capabilities, the structure again including, without limitation, any of whole bamboo, as well as composite strips of natural fibers including any of corn stalks, sugar cane and the like;

FIG. 17B is a succeeding partial perspective illustration of an attachable side location of the frame structure in which a netting material is added; and

FIG. 17C is an enlarged partial illustration taken along either of mirroring sections C of FIG. 17B and illustrating the netting material being looped around a rod which is locked inside of a metal tube through a slot.

### DETAILED DESCRIPTION OF THE PREFERRED EMBODIMENTS

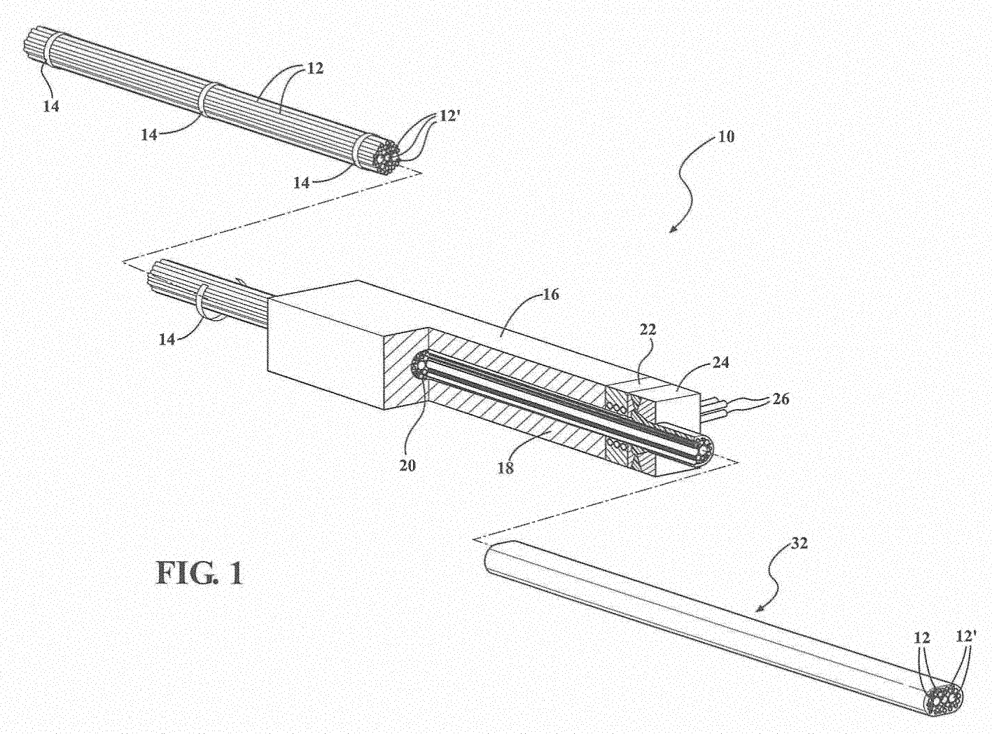

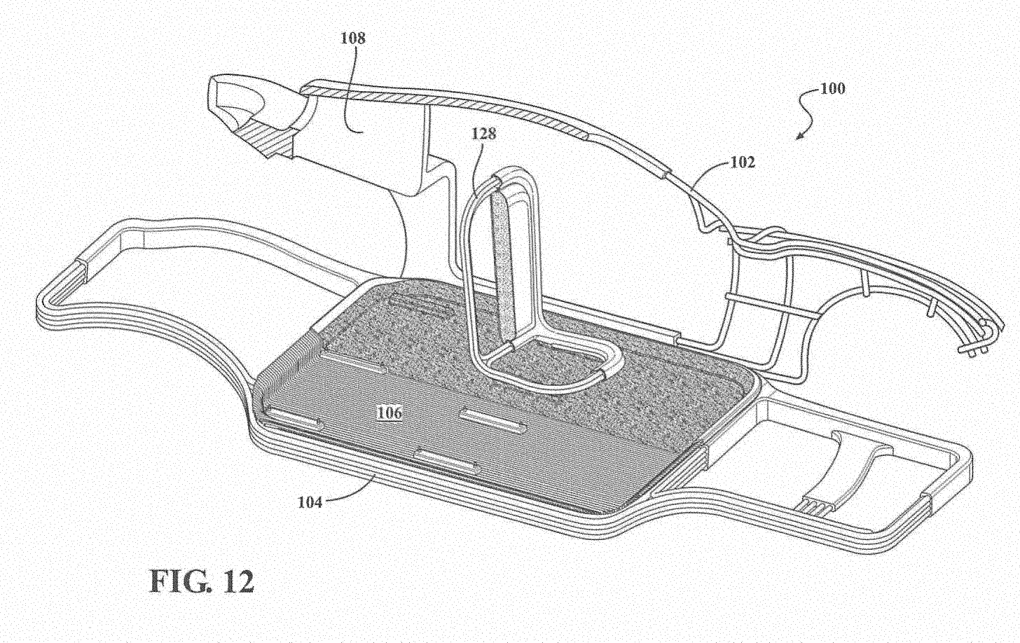

With reference to the attached illustrations, the present invention discloses, in a first embodiment, an extruding process, at 10 in FIG. 1, for creating a structural form, not limited to any of building blocks, sheets and the like, and such as is used in building and other construction applications. In a further embodiment of the present invention, at 100 in FIG. 12, the present invention additionally teaches any type of encapsulation or coating process for use with a fiber structure, such as a frame, seat or flooring support, utilized in any of a vehicle or other support structure.

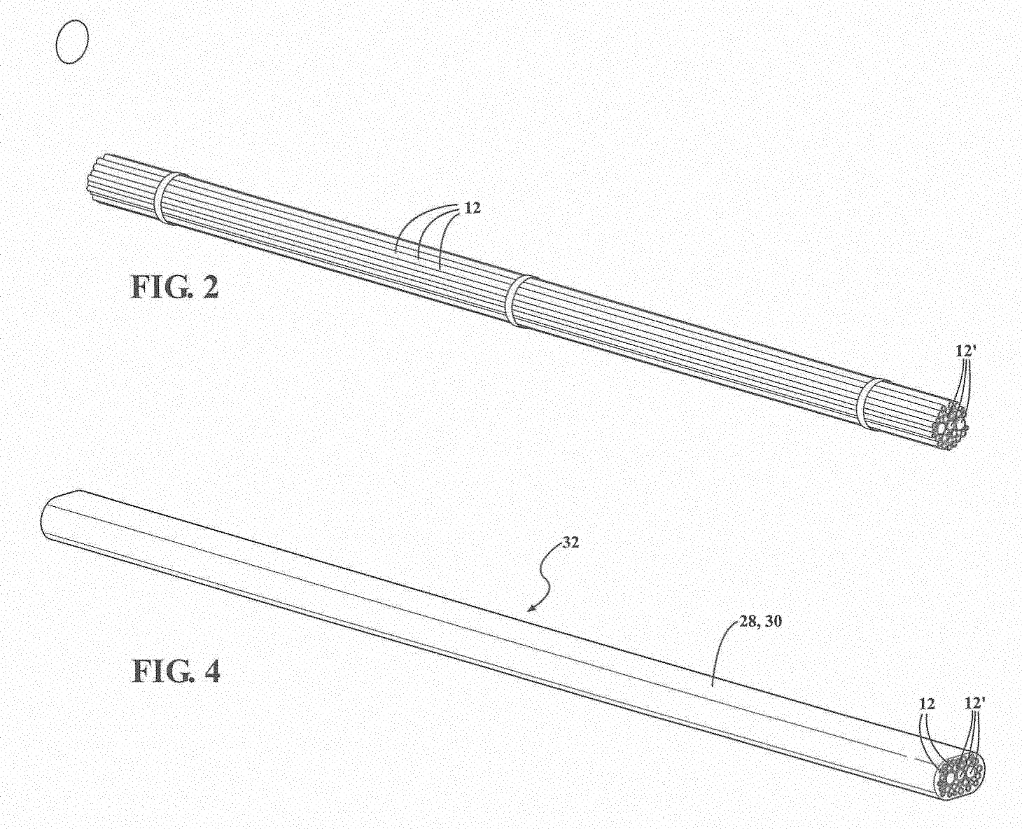

Referring initially to FIG. 1, the line process 10 is again depicted for extruding a structural and environmental sealing coating about successive bundled pluralities of naturally occurring materials, these shown at 12, according to one embodiment of the present inventions. FIG. 2 is an illustration from FIG. 1 of a selected bundled plurality of the naturally occurring material, again at 12, such having any of stiff, rigid or fibrous physical properties and which is not limited to any of bamboo, bamboo strips, cane stalks, corn stalks, palm leaves, reeds, and the like. As further shown in each of FIGS. 1 and 2, the bundled plurality of materials can include those of varying diameters (see sub-plurality of larger diameter materials 12′ embedded within a larger plurality of smaller diameter materials again at 12),these being pre-arranged in a desired bundled and elongate extending pattern and bound by straps 14.

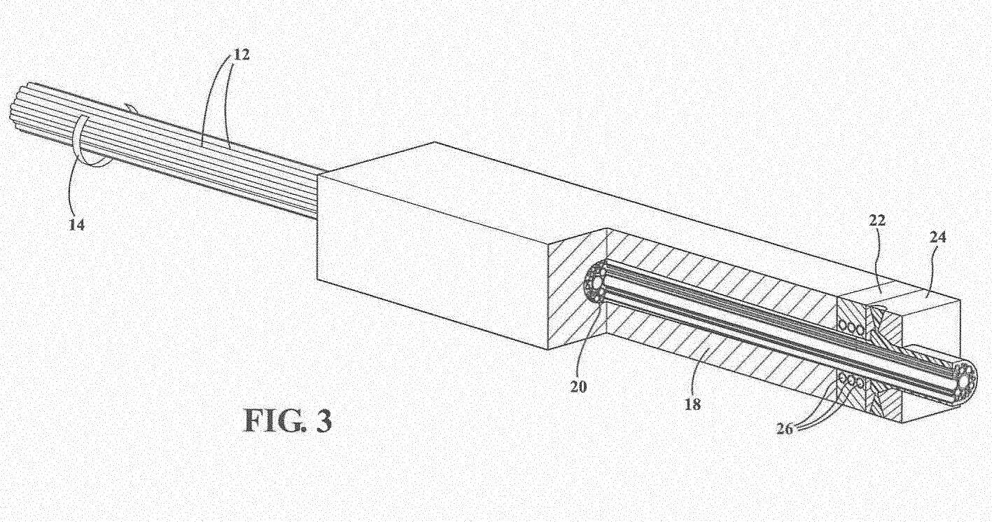

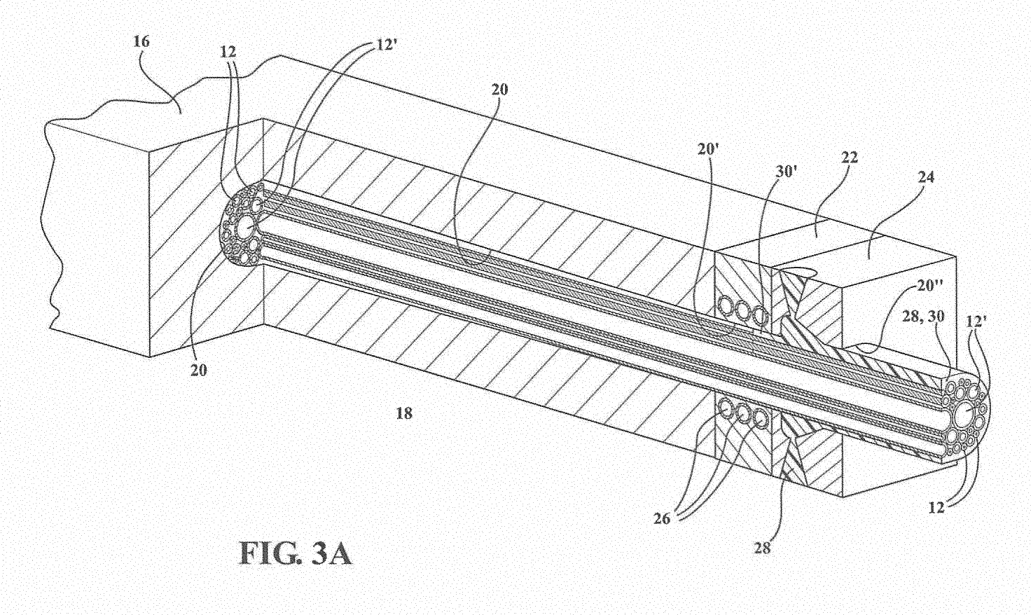

FIG. 3 is an illustration of a succeeding operation including a three stage extruder, overall at 16, and having a three dimensional extending body within which is defined a conveying cross sectional profile interior corresponding to that of a desired shaping to be imparted to the elongated material being conveyed therethrough. The extruder 16 is depicted in cutaway and through which the unbundled (by removal of straps 14) bunch of materials 12, 12′ are successively conveyed in order to shape and extrude the applied materials.

FIG. 3A is an enlarged depiction of FIG. 3 and illustrating the three stages of the extruder 16. This includes each of a first subset stage 18, in which a length extending reshaping profile (at 20) is configured within the extruder for reshaping the through fed cross sectional area of the unbundled plurality of materials 12, 12′ of varying respective diameters (these depicted as a bundle of bamboo lengths) and so that it matches the corresponding to the profile (again perimeter 20) defined within the extruder.

A second intermediate chilling stage, see subsection 22, separates the first formation stage 18 from a third material extrusion stage 24. A plurality of chiller pipes 26 extend from external locations (see FIG. 1) to surround the inner reforming perimeter 20 traversing through the second chiller stage 22 (again FIG. 3A). A suitable coolant (not shown) is communicated through the pipes 26, such as by a pump or other flow mechanism, and which operates to prevent the extruded material from the third stage 24 from flowing backwards into the first bundling stage.

Finally, at the third end heated and extruding stage 24, an extrusion material (see at locations 28 and 30 in the FIG. 3A cutaway) is heated, liquefied and pressure introduced, via such as a cross head die at specified perimeter locations, and in order to flow around and between the individual structural materials 12, 12′, which are distributed within the open interior profile of the extruder (for clarity of explanation the interior reforming profile is depicted at 20 within the first main reshaping stage, at 20′ within the chiller stage and, finally at 20″ within the extruder stage). The extruded material 28/30 may include, without limitation, any of a foaming polyurethane, polyurea, polyethylene, bio-plastic or the like, such further optionally including any infused filler, natural fiber, carbon fiber, metal particulates, shavings, or the like

It is envisioned that a suitable catalyst, such as a structural foaming agent or the like, can also be included with the extruded material and which, upon introduction, assists in cross sectionally positioning, and supporting the individual lengths of the naturally occurring material (lengths 12, 12′) in a manner which provides a desired cross sectional profile distribution. As further shown in FIG. 3A, the extruded material is restricted (see at 30′) from back-flowing beyond a portion of the length of the second chiller stage 22, this again owing to the chiller pipes 26 which momentarily solidifies the extruded material, and which is re-melted during conveying through the extrusion stage 24 by the heat associated with the arrangement of thermocouples and coils (not shown). Although not shown, it is understood that additional options are provided for cooling the extruded bundles of elongated fibers, such including the provision of any suitable cooling spray tank or the like for assisting in faster solidification of each finished part according to any production line process.

FIG. 4 is an illustration of a finished extruded structural product, generally shown at 32 from another angle compared to FIG. 1, and which is cut to length in a succeeding operation prior to package and shipment for subsequent use or installation. As depicted by the exposed end profile of the structural article 32, the varying diameter bundled materials (bamboo lengths) 12, 12′ are cross-sectionally distributed in structurally supported and inter-suspended fashion by the extruded and hardened (optionally expanded) polymer foam or composite material (again including without limitation any of foaming polyurethane, polyuria, polyethylene, bio-plastics or the like), and such as further which may include any infused natural or synthetic fillers, natural fibers, carbon fibers, metal pieces and the like. Without limitation, the composition of the extruded material and/or the manner in which the extruder heats and injects the material, can be modified to in order to vary any of the profile, dimensions or cross sectional distribution of the elongated naturally occurring materials (again without limitation bamboo lengths 12, 12′).

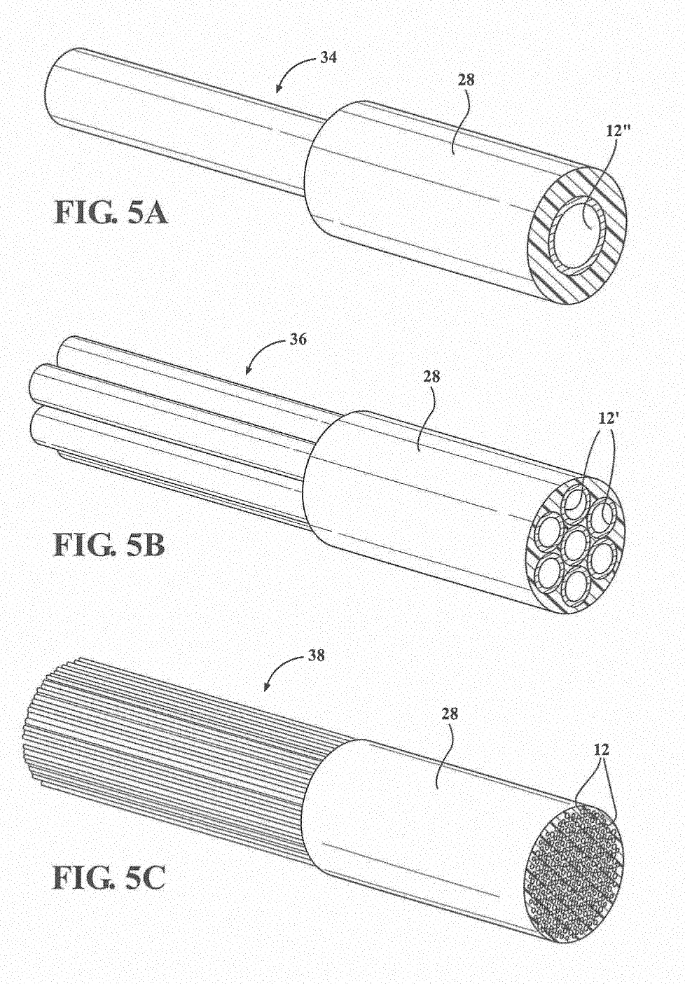

Having provided a general explanation of the line process and extruder operation, FIGS. 5A-5C illustrate examples of extruded round cross sectional posts which can be produced using any type or variation of extruder. This includes the provision of different sized structural materials in varying orientations and patterns, by example a single larger diameter hollowed member 12″ surrounded by the extruded material 28, generally at 34 in FIG. 5A. A small plurality of intermediate diameter cross sectional distributed members, again at 12′ are shown encased by the extruded material 28, generally at 36 in FIG. 5B. By further example, a larger plurality of the smallest diameter naturally occurring bamboo or other materials 12 are encased within the extruded material 28 as generally shown at 38 in FIG. 5C, about and between which the extruded material is again applied or introduced in an alternate fashion to that shown in FIG. 5B.

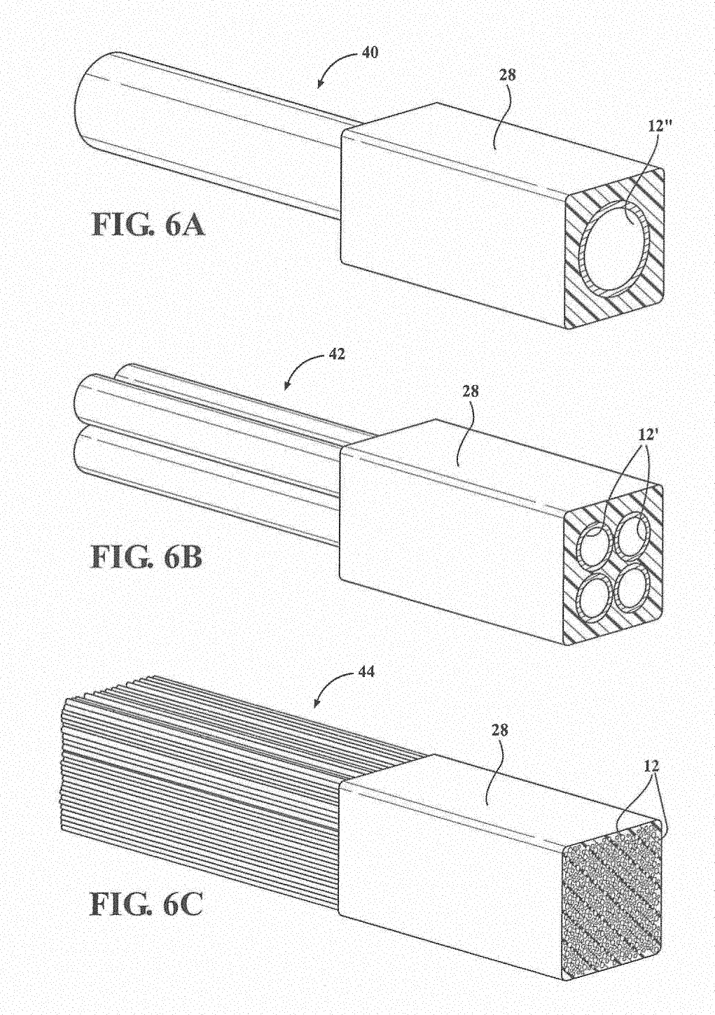

FIGS. 6A-6C are similar to FIGS. 5A-5C and illustrate examples of extruded square cross sectional posts, generally at 40, 42 and 44 respectively, which similarly utilize the larger 12″, medium 12′ and smallest 12 cross sectional diameter naturally occurring material structural members. To achieve the shapes of FIGS. 6A-6C, the profile configuration of the extruder depicted in FIGS. 1 and 3A is modified (such that the rounded interior communication passageway 20 is redesigned in a square or polygonal shape).

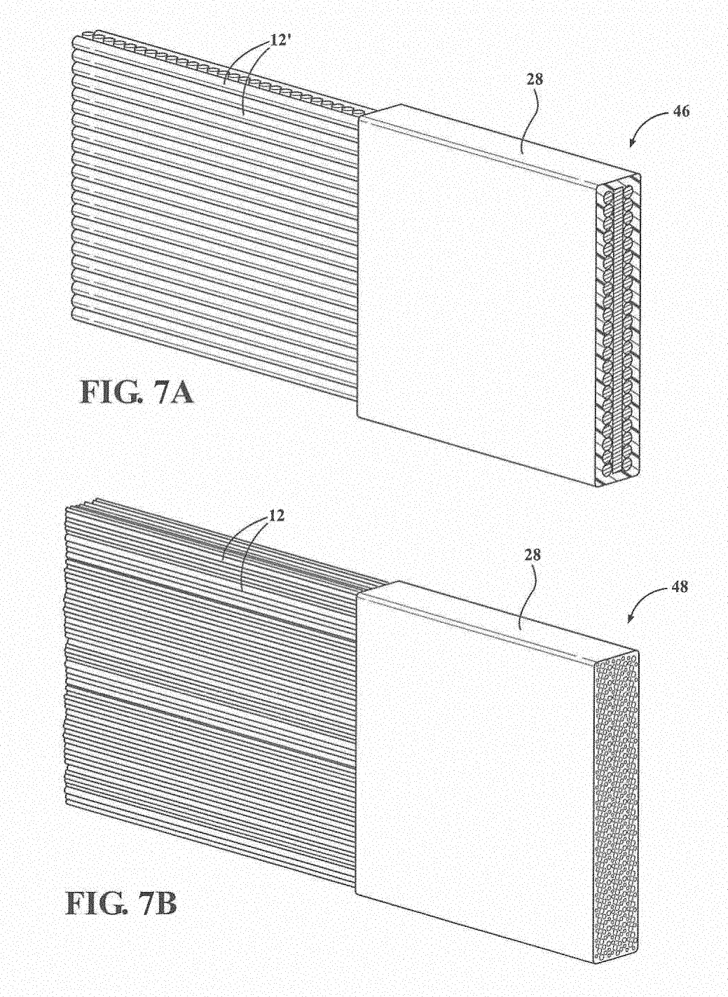

FIGS. 7A-7B illustrate further variants of a rectangular cross sectional structural articles, see generally at 46 and 48. As shown, these are produced with preformed and cross cut lengths (bamboo) of intermediate 12′ (FIG. 7A) and smallest 12 (FIG. 7B) diameter, about which is extruded the structurally supporting binding and sealing material, in each instance again at 28.

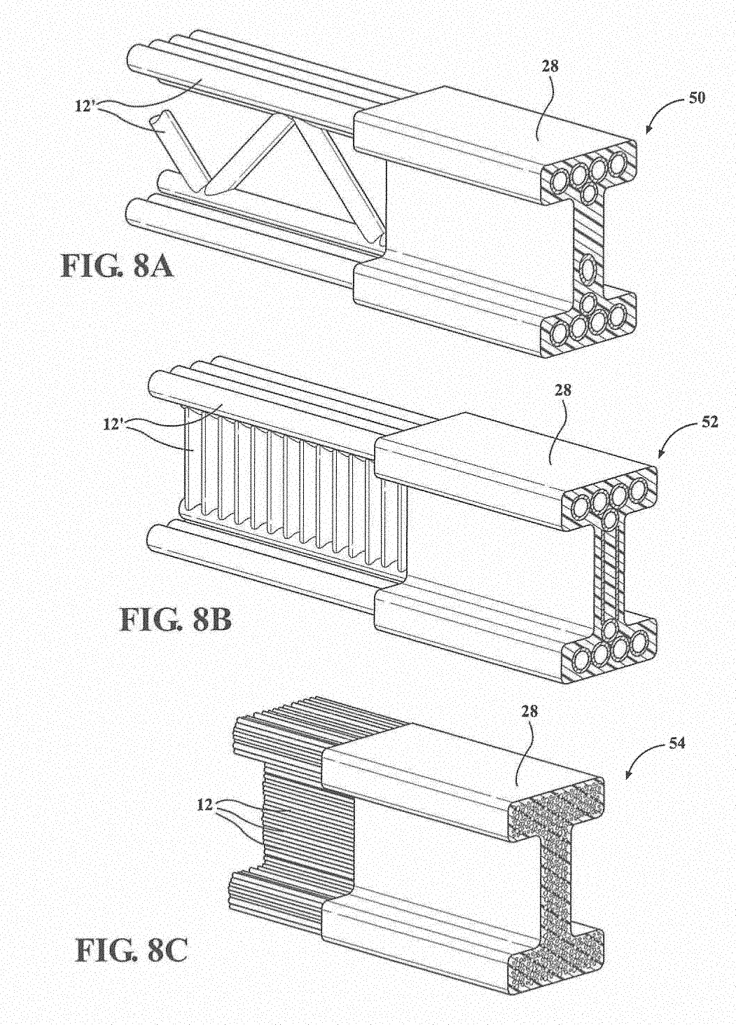

FIG. 8A-8C illustrate additional unique “I” beam like structures, generally at 50, 52 and 54 respectively, and which can include varying orienting structure for pre-forming the naturally occurring material from intermediate diameter and varying oriented sections of material prior to extruding the outer structural supporting material. FIG. 8C depicts a smallest diameter and larger plurality of elongated structural materials 12, such as which can be passed through the extruder of FIG. 1, and about and between which is introduced the structural supporting and sealing extruded material 28. FIGS. 8A-8B further depicted varied and irregular arrayed members 12′, such envisioning preforming of the structures in a separate operation prior to passing through a further redesigned extruder cavity, and to introduce the extruded material 28 in the manner depicted.

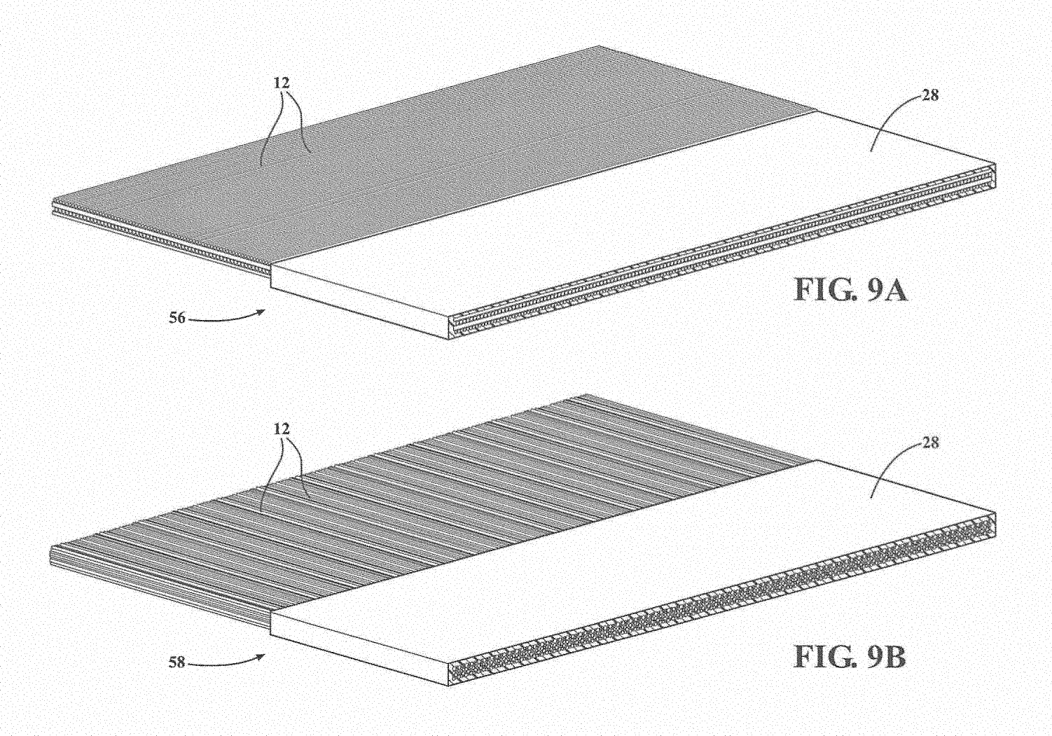

Proceeding to FIGS. 9A-9B, a pair of extruded articles are generally shown at 56 and 58 operations in which a suitable arrangement of structural materials, such as again including precut and/or preformed lengths of bamboo or other naturally occurring materials 12 extending either widthwise, as again shown at 56 in FIG. 9A, or lengthwise, as again shown at 58 in FIG. 9B. It is further noted that the arrangement of the materials fed continuously through an appropriately redesigned extruder applies a thinner cross sectional profile, as compared to that shown in the previous embodiment of FIGS. 7A-7B, and in order to create a sheet-like article which replicates many of the properties of structural wallboard, flooring or paneling.

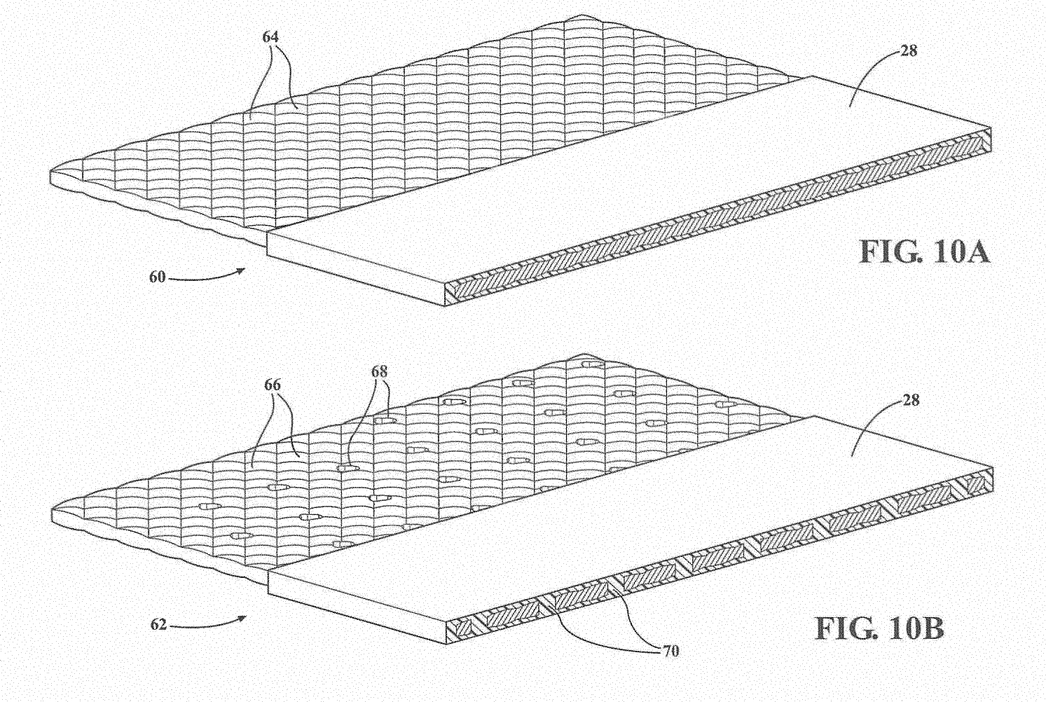

FIGS. 10A-10B illustrate first 60 and second 62 sub-variants of a ply-fiber material, these depicted at 64 and 66 respectively as cross weave mat constructions and which are arranged in a weaved pattern prior to extruding the material 28. In the instance of FIG. 10B a perforated pattern, see punch-out locations 68, are formed through the material for providing additional extrusion adhesion as reflected by segmented extrusion binder locations (further at 70 as depicted in the end profile of FIG. 10B).

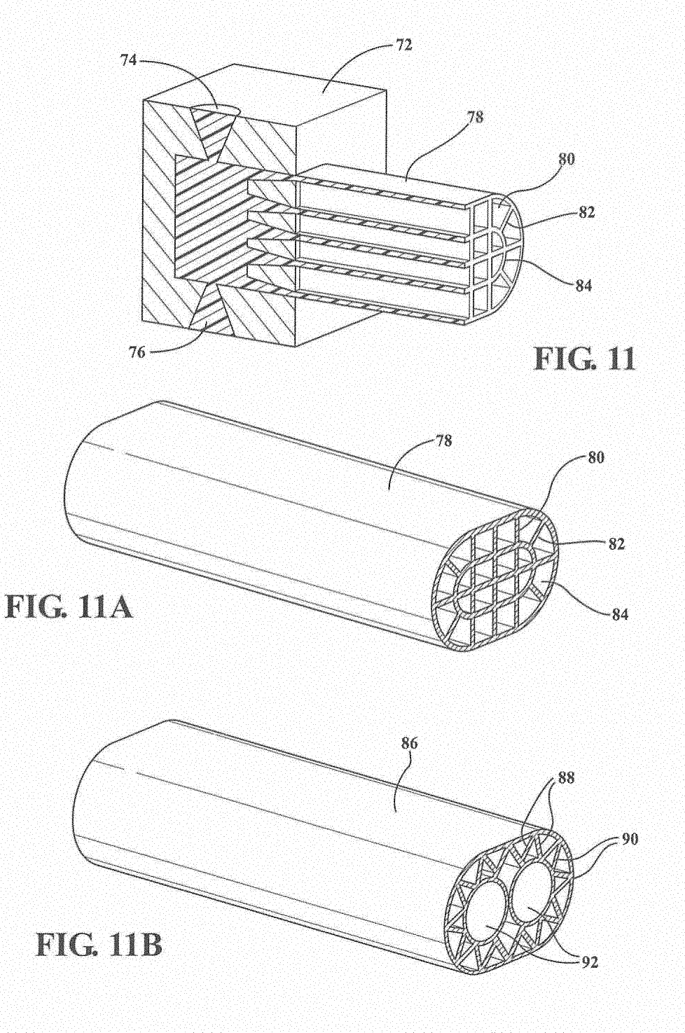

FIG. 11 is an illustration of a further embodiment of the present invention incorporating a redesigned extruder 72, this shown in cutaway and operating in a single stage through which is inputted an infused structural material contained within the extrudant, the material depicted at in-feed locations 74 and 76 and being oriented by the tool for extruding according to a detailed cross sectional profile to create a detailed structural article, further shown at 78 and including a collection of intersecting ribs 80, 82, 84, et seq., which define a plurality of parallel extending cavities within the formed structural article. As additionally depicted in the partially enlarged end perspective profile of FIG. 11A, the extruded structural article can exhibit any degree of detail, as reflected by the configuration of the associated cross head die which permits the structural particulates admixed into the extruded material to be of a sufficiently fine grade.

In this manner, the combined extruded material can flow completely across and between the channels and guides associated with the cross head introduction locations (again 74/76) in non-interrupted fashion and in order to complete the cross sectional profile shown to a high degree of accuracy and consistency. FIG. 11B is a further end perspective, at 86, of a reconfiguration of the extruder in FIG. 11 which enables the production of another detailed profile as reflected by reconfigured rib locations 88, 90, et seq., as well as redefined inner circular patterns 92 which are a reflection of the detail associated with the cross head die construction of the associated extruder. In this manner, the finely graded and, typically naturally occurring, structural materials is integrated into the extruded polymer material (again including any of the options previously described) and creates a single integrated recipe which is extruded into the desired structural article utilizing the extruder previously described.

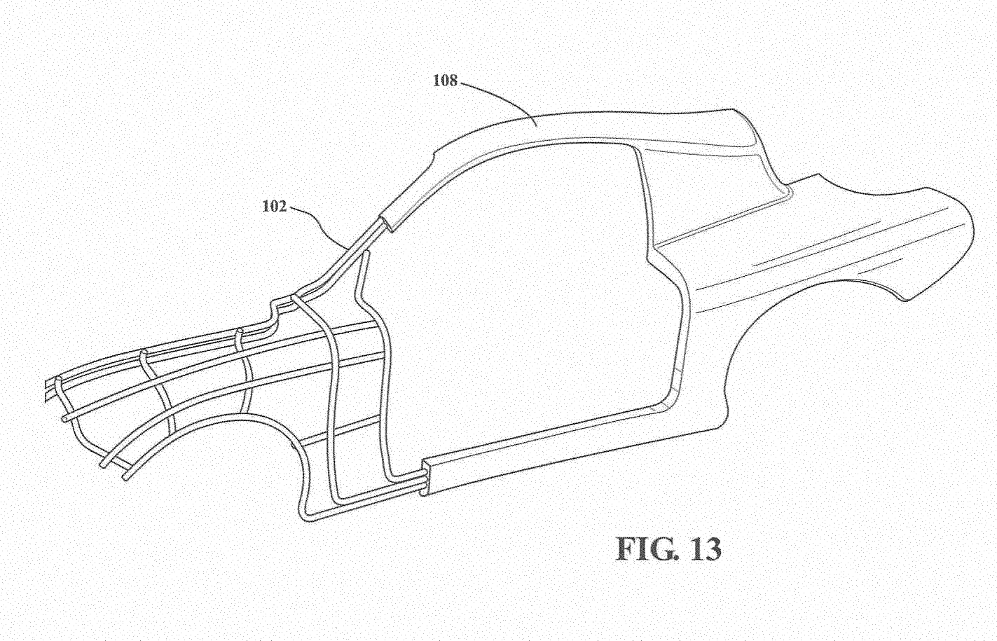

Proceeding to FIG. 12, an illustration is again generally shown at 100 of a fiber structure according to a further embodiment, and which can form any multi-component frame structure, this not limited to any type of vehicle (car, bus, truck, golf cart) or marine craft. FIG. 13 is a rotated perspective of an assembled frame side section, at 102, forming a portion of the frame structure of FIG. 12, and such as which also includes a separate assembled floor outer frame section 104 and inner support platform section 106.

The frame sections 102/104/106 each include a plurality of interconnected lengths or sections, and can be pre-assembled from any natural fibrous material not limited to bamboo, sugarcane, plant stalks, corn, phragmite (tall grasses), etc., such as which are formed of any of whole poles or strips/fibrous composites, and in order to create a skeleton of the eventual structural supporting article. To this end, any of glues adhesives or other types of mechanical fasteners can be employed for creating each skeletal structure.

The frame sections 102/104 are subsequently encapsulated by any type of structural foam, shown at 108, and including any of a polyurethane, polyurea, polyethylene or bioplastic material. Encapsulation can be provided in a variety of different manners, not limited to a modification of the extrusion process previously shown but also including any type of molding, manual or robotic numerical controlled application of the structural encapsulating material or other manner of applying a determined thickness of structural foam (including optionally the inclusion of expanding and solidifying catalysts or like ingredients which are responsive to any of air, heat, pressure, light, water or the like for setting and hardening).

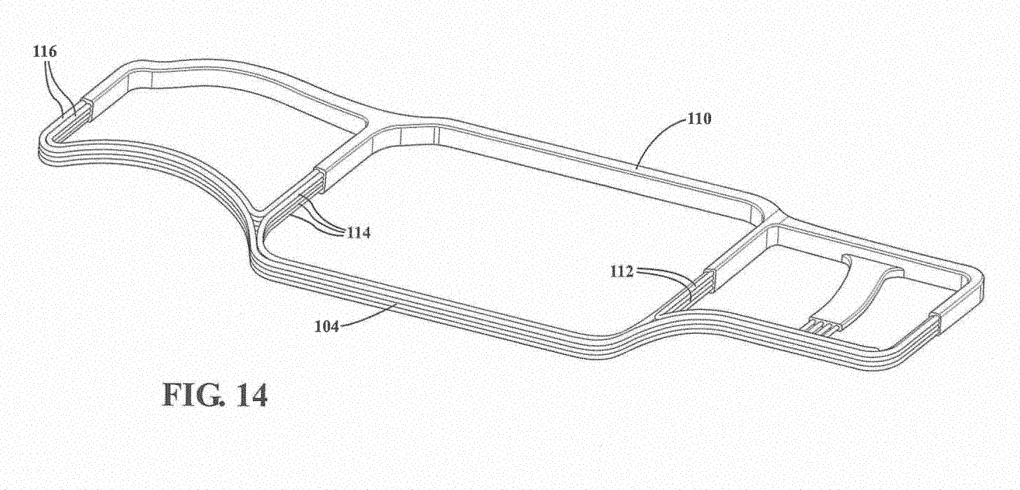

FIG. 14 is an illustration of the performed floor frame structure, again at 104, such as used for any structural body frame or interior application, and which is assemble together prior to encapsulation with the polymer based structurally supporting material, at 110 (such again further including any structural foam which may include strands of fibers added for rigidity). Without limitation, the floor frame structure includes without limitation and combination of hollow conduit like material, and which includes the frame being constructed of pluralities of length and crosswise extending portions (see further at 112, 114, 116).

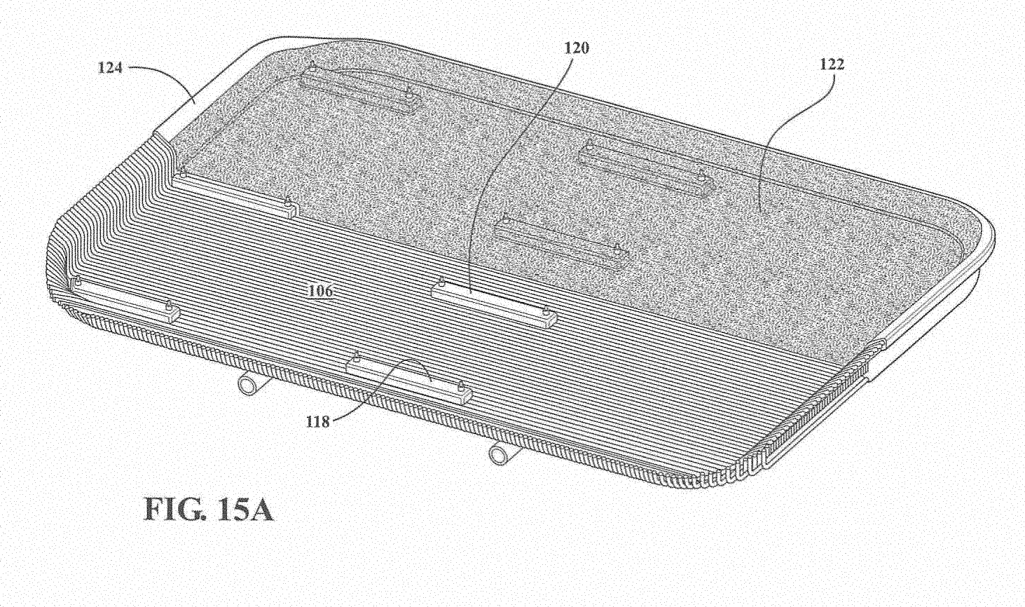

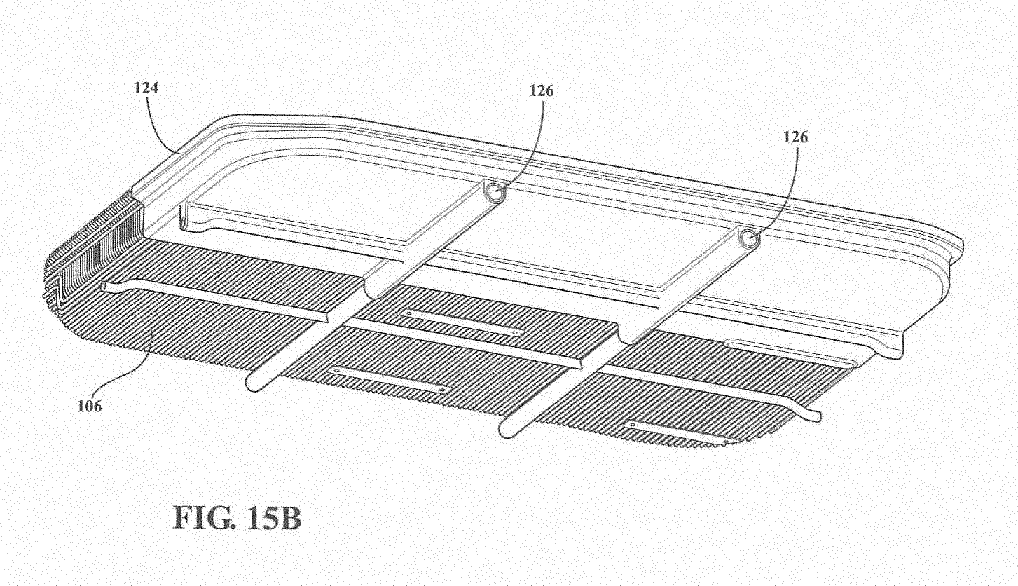

FIG. 15A and 15B respectively present upper and underside perspective illustrations of the pre-formed flooring structure previously identified at 106, such as for any interior, trunk wall or flooring application. As with the previous descriptions, the structure can include any of bamboo, bamboo strips, corn, sugarcane, what or any other natural occurring fibrous material, with metal or plastic components, see at 118, 120, et seq., optionally being integrated into the structure for part attachment locations (similar components of varying shape can also be integrated into the outer floor frame section 104 or the side assembled frame sections 102).

Additional features including fabric or carpet, at 122, can be in-molded during encapsulation of the material (depicted by section at 124). Other features include under supporting hollow conduit support structures, at 124 and 126, such as for routing electrical wiring (not shown), these being incorporated into the underside of the floor section 106.

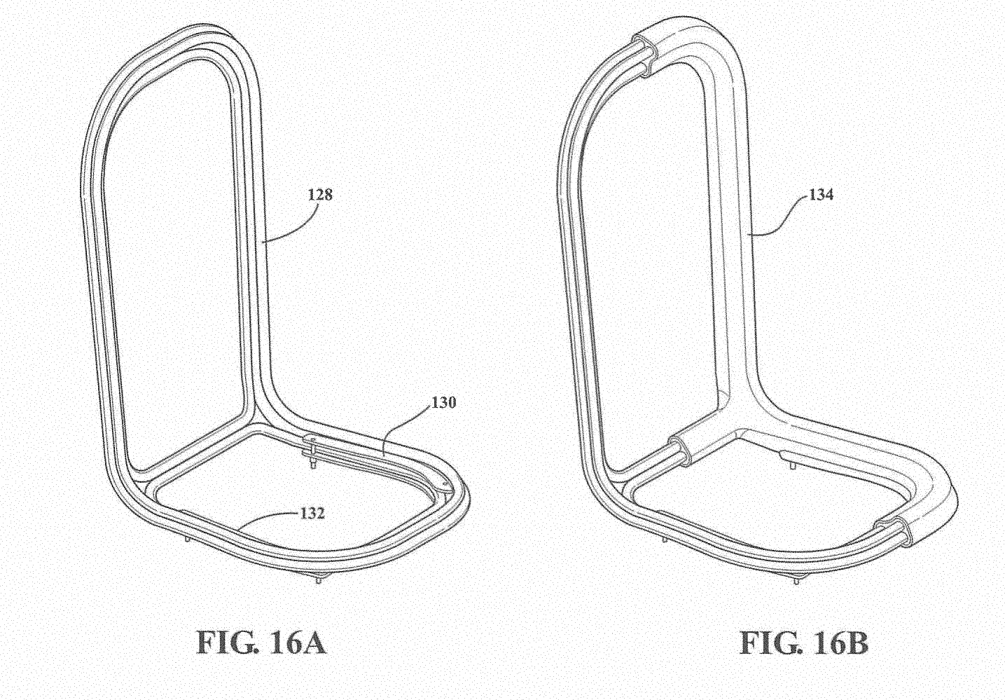

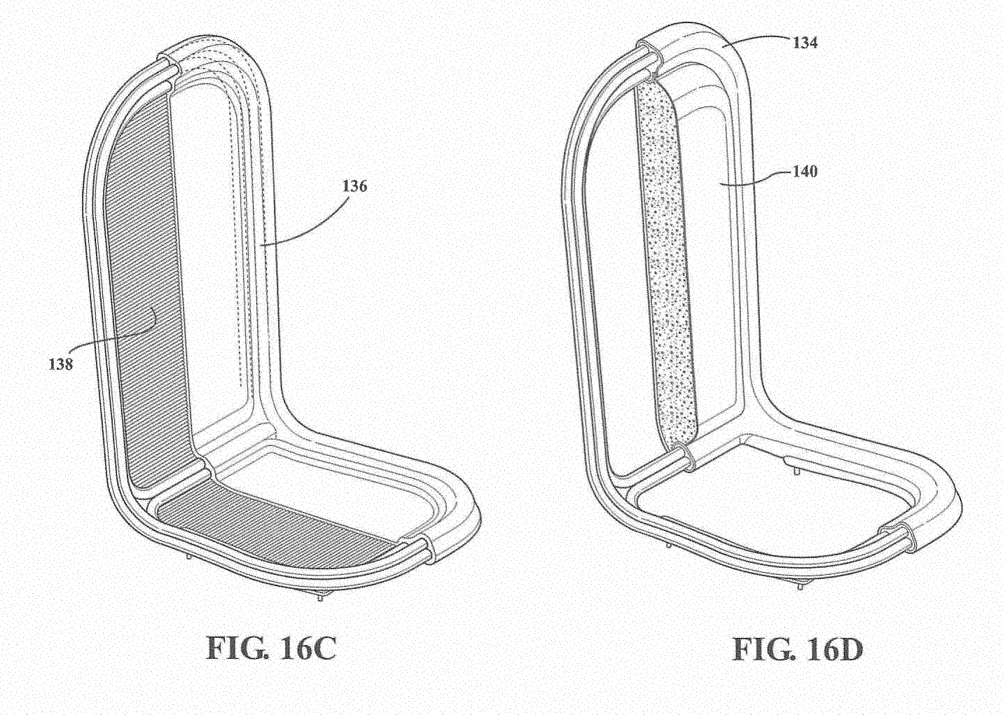

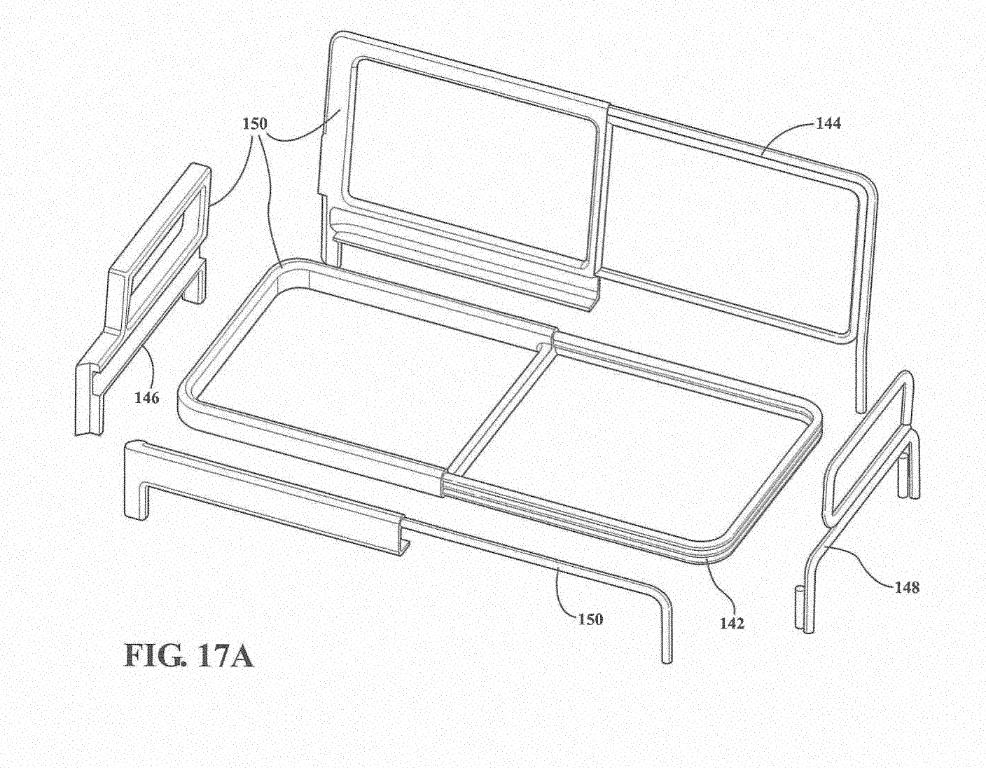

FIG. 16A illustrates a seat application of the fibrous material encapsulating process and assembly, this including a preassembled skeletal seat frame (see at 128 and as previously shown in FIG. 12 secured upon floor attachment components 118/120). As with the other frame defining sections 102-108, the seat frame 128 can include pluralities of shaped fibrous elements which are bent or configured into the desired skeleton, this using any known structure, assembly or technique. Also shown is an interior structural application of metal or plastic brackets, at 130 and 132, integrated into the structure for subsequent part attachment.

FIG. 16B is a succeeding view to FIG. 16A and illustrates an open (hollow interior) structure or more solid interior structure made up of integrated strands or fibers and in which a fabric material, at 134, can be molded on during the encapsulation process. FIG. 16C is a further succeeding view depicting the addition of an encapsulating foam 136, such applied following a pre-attachment of an underlying fiber substrate 138, this collectively providing a structural process which is not only lighter but, by integrating more components into one bonded part, reduces vibration or rattle incidences along with reducing assembly time. FIG. 16D is a further succeeding illustration of a final upholstery, at 140, attached to the completed seat (the inner foam 136 and fiber 138 substrates not being shown in this view for clarity of presentation).

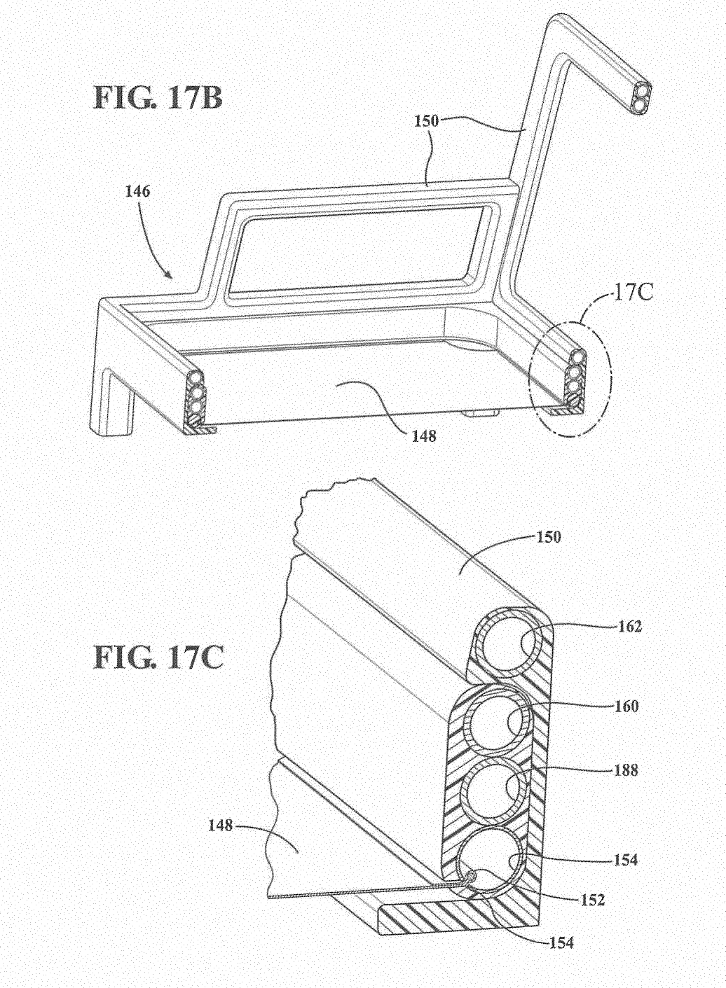

FIG. 17A is an illustration of a furniture structure including a plurality of individual frame defining components or skeletal sections, this including base 142, back 144, sides 146/148 and front bottom 150. The individual skeletal sections can be pre-formed, aligned (such as with any appropriate jig or fixture) and bonded together, again with the use of any type of structural foam which can further incorporate any fiber of filler additive for improved strength and to provide enhanced hardware attachment capabilities. The structures depicted again include, without limitation, any of whole bamboo, as well as composite strips of natural fibers including any of corn stalks, sugar cane and the like.

FIG. 17B is a succeeding partial perspective illustration of an attachable side location section, again at 146, with the bottom or base 142 frame section, and in which a netting material 148 is added to the structure and secured about the bottom perimeter defined therebetween. As also shown, the encapsulating material is generally shown at 150 for coating all of the sections. With final reference to FIG. 17C, an enlarged partial illustration is taken along either of mirroring sections C of FIG. 17B and illustrates the netting material 148 being looped around a rod 152 which is locked inside of a metal tube 154 with a through defined slot 156, the tube being integrated into the side structures 146/148 as a separate fitting or component in addition to the naturally occurring structural supporting (such as bamboo) components which are further shown at 158, 160, 162 and about which is encapsulated the structural sealing and supporting material.

Having described my invention, other and additional preferred embodiments will become apparent to those skilled in the art to which it pertains, and without deviating from the scope of the appended claims:

I claim:

1. An extruding process for creating a structural form, comprising the steps of:
bundling and conveying an elongated material into an extruder;
reshaping a cross section of the bundled material in a first stage of the extruder;
extruding a flowable and settable thermoplastic, using any combination of heat and pressure, around and between the material;
setting and hardening the thermoplastic; and
outputting a finished article having a cross sectional profile in which the material is structurally supported by the extruded and hardened material.

2. The process of claim 1, further comprising the step of chilling the bundled material between reshaping and extruding, to prevent the extruded thermoplastic from back flowing into the reshaping step.

3. The process of claim 1, said step of extruding a thermoplastic further comprising providing any of a polymeric or structural foam material.

4. The process of claim 1, said step of outputting a finished article further comprising providing any of a rounded, square, rectangular or I beam cross sectional profile.

5. The process of claim 1, further comprising the steps of:
infusing a finely graded naturally occurring material within the flowable thermoplastic material;
forcing the infused combination through a cross die head structure associated with an extruder; and
forming the finished article as a partially hollowed cross sectional profile exhibiting any combination of ribs or compartments.

6. A process for encapsulating a pre-assembled frame article, comprising the steps of:
configuring a plurality of naturally occurring fiber structures into a skeletal frame; and
encapsulating the skeleton with a structural foam.

7. The process of claim 6, further comprising the step of integrating a mounting or support hardware components not limited to a plastic or metal into locations of the fiber skeleton.

8. The process of claim 6, further comprising the step of providing any of a fabric, carpet, foam or upholstery incorporated into the skeleton structure.

9. The process of claim 6, further comprising the step of shaping the skeleton frame to include any of a vehicle, floor, side, or base structure, or seat.

10. The process of claim 9, further comprising the step of integrating underside structural supporting conduit attachments into a floor structure configured by the skeleton frame

11. The process of claim 6, further comprising the steps of providing the skeleton frame as a furniture structure and looping a netting material around a rod which is locked inside of a metal tube with a through defined slot within a side supporting section of the structure, the tube being integrated as a separate fitting in addition to naturally occurring structural supporting components and about which is encapsulated the structural sealing and supporting material.

12. An extrusion assembly for forming a structural article integrating an elongated fibrous organic material, comprising:
an extruder through which is advanced a bundle of the elongated material;
a first section of said extruder having an interior passageway configured for reshaping a cross sectional profile of the bundle of material; and
a second section of said extruder incorporating a cross head die for introducing a flowable thermoplastic around and between the reshaped bundle of material;
the extruder outputting a finished article having a cross sectional profile dictated by said first section and said cross head die and in which the material is structurally supported by the extruded and hardened material.

13. The assembly of claim 12, said extruder further comprising a fluid cooled chiller unit between said first and second sections for preventing backflow of the flowable thermoplastic into said first section.

14. The assembly of claim 12, said flowable thermoplastic material further comprising any of a polymeric or structural foam material.

15. The assembly of claim 12, further comprising the cross head die shaping the finished article according to any of a rounded, square, rectangular or I beam cross sectional profile.

16. The assembly of claim 12, further comprising said cross head die forming the finished article as a partially hollowed cross sectional profile exhibiting any combination of ribs or compartments.

17. The assembly of claim 12, further comprising a finely graded naturally occurring material infused within the flowable thermoplastic material.
